(19) United States
(12) Patent Application Publication
(10) Pub. No.: US 2010/0048396 A1
(43) Pub. Date: Feb. 25, 2010

(54) METHOD, USE AND AGENT FOR PROTECTING A PLANT AGAINST PYTHIUM AND RHIZOCTONIA

(76) Inventors: Paul Cavell, Ludwigshafen (DE); Andreas Romeijn, Speyer (DE); Egon Haden, Ludwigshafen (DE)

Correspondence Address: BIRCH STEWART KOLASCH & BIRCH, PO BOX 747, FALLS CHURCH, VA, 22040-0747, US

(21) Appl. No.: 12/522,020

(22) PCT Filed: Jan. 16, 2008
(86) PCT No.: PCT/EP2008/050460

§ 371 Date: Jul. 2, 2009

(30) Foreign Application Priority Data
Jan. 17, 2007 (EP) 07100706.6

(51) Int. Cl. A01N 25/26; A01N 43/653; A01P 3/00

(52) U.S. Cl. 504/100; 514/383

(57) ABSTRACT

The present invention relates to a method for protecting a plant against a phytopathogen selected from the genera Pythium and Rhizoctonia, wherein the seed of the plantis treated with (a) triticonazole or anagriculturally acceptable salt thereof and (b) prochloraz or anagriculturally acceptable salt thereof.

The present invention relates to a method, use and agent for protecting a plant against a phytopathogen selected from the genera Pythium and Rhizoctonia.

EP 0 378 953 describes 2-(4-chlorobenzylidene)-5,5-dimethyl-1-(1H-[1,2,4]-triazol-1-ylmethyl)-1-cyclopentanol, a process for its preparation and its use as fungicide.

EP 0 466 612 describes fungicidal compositions comprising 2-(4-chlorobenzyliden)-5,5-dimethyl-1-(1H-[1,2,4]-triazole-1-ylmethyl)-1-cyclopentanol and a further fungicide for controlling fungicidal diseases on crops by foliar application.

EP 0 467 792 describes fungicidal compositions comprising 2-(4-chlorobenzyliden)-5,5-dimethyl-1-(1H-[1,2,4]-triazole-1-ylmethyl)-1-cyclopentanol and a further fungicide for seed treatment. In order to control Rhizoctonia the further fungicide is a dicarboxylmide such as ipriodione, a phenyl urea derivative such as pencycuron, an anilide such as mepronil or flutolanil, or a phosphorous derivative such as toclophos-methyl.

The use of (E)-5-(4-chlorbenzyliden)-2,2-dimethyl-1-(1H-1,2,4-triazol-1-yl-methyl)cyclopentanol (hereinafter referred to as triticonazole) for combating rust attacks on soya plants is described in WO 2005/122771.

U.S. Pat. No. 3,991,071 and U.S. Pat. No. 4,080,462 describe N-{propyl-[2-(2,4,6-trichlorophenoxy)ethyl]}imidazole-1-carboxamide (hereinafter referred to as prochlo-raz), a process for its preparation and its use as fungicide.

Simplified crop rotation, relatively sensitive high-yield crop varieties and a desired rapid growth along with adverse weather conditions of high humidity have favoured an increased occurrence of pathogenic fungi, such as Rhizoctonia and Pythium, over recent years. There have been considerable harvest and yield losses especially with seedlings.

Most customary fungicides are unsuitable or unsatisfactory for controlling such pathogenic fungi.

An object of the present invention was to provide a method for the protection of crops from damage by said phytopathogenic fungi. Preferably, it should also solve the problem of reducing the dosage rate, combine knock-down activity with prolonged control and/or be suitable for resistance management.

Surprisingly, it has now been found that the abovementioned harmful fungi can efficiently be controlled and thus the disease on certain plants which is caused by these harmful fungi can be controlled by treating the seed of said plants with triticonazole and prochloraz.

Accordingly, the invention relates to a method for protecting a plant against a phytopathogen selected from the genera Pythium and Rhizoctonia, wherein the seed of the plant is treated with (a) triticonazole or an agriculturally acceptable salt thereof and (b) prochloraz or an agriculturally acceptable salt thereof.

The invention also relates to the use of (a) triticonazole or an agriculturally acceptable salt thereof and (b) prochloraz or an agriculturally acceptable salt thereof for protecting a plant against a phytopathogen selected from the genera Pythium and Rhizoctonia.

The invention further relates to an agent for treating seed of a plant for protecting the plant against a phytopathogen selected from the genera Pythium and Rhizoctonia, the agent comprising (a) triticonazole or an agriculturally acceptable salt thereof and (b) prochloraz or an agriculturally acceptable salt thereof.

Triticonazole (component a) is a known fungicide from the group of the triazoles, i.e., (E)-5-(4-chlorbenzyliden)-2,2-dimethyl-1-(1H-1,2,4-triazol-1-ylmethyl)cyclopentanol of the formula (I):

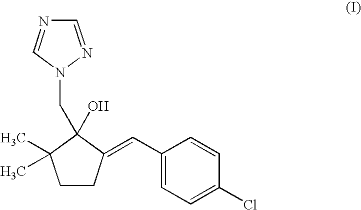

According to a particular embodiment, triticonazole is the essentially enantiomerically pure compound of the formula I-R, or the essentially enantiomerically pure compound of the formula I-S

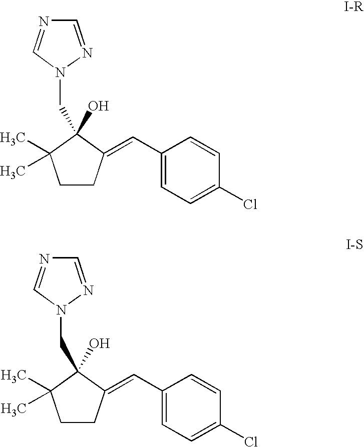

or a mixture of both enantiomers, e.g. the racemic mixture.

In the context of the present invention, “essentially enantiomerically pure compounds of the formula I-R or I-S” is to be understood as meaning that these compounds are pre-sent in an enantiomeric purity of in each case at least 85% ee, preferably at least 90% ee, particularly preferably at least 95% ee, more preferably at least 96% ee, even more preferably at least 97% ee and in particular at least 98% ee, for example at least 99% ee.

Prochloraz (component b) is a known fungicide from the group of the imidazoles, i.e., N-{propyl-[2-(2,4,6-trichlorophenoxy)ethyl]}imidazole-1-carboxamide of the formula (II):

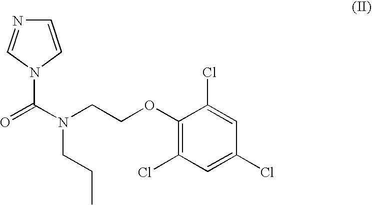

Suitable agriculturally acceptable salts of triticonazole or prochloraz include in particular the acid addition salts. Acid anions of suitable acid addition salts are, for example, chloride, bromide, fluoride, hydrogen sulfate, sulfate, dihydrogen phosphate, hydrogen phosphate, phosphate, nitrate, bicarbonate, carbonate, hexafluorosilicate, hexafluoro-phosphate, benzoate and the anions of C₁-C₄-carboxylic acids, such as formate, acetate, propionate and butyrate.

Processes for preparing triticonazole are known in principle and described, for example, in EP 0 378 953, the entire content of which is expressly incorporated herein by way of reference. The acid addition salts of triticonazole can be prepared by reacting triticonazole with an acid of the corresponding acid anion and preferably with hydrochloric acid, hydrobromic acid, sulfuric acid, phosphoric acid or nitric acid.

Processes for preparing prochloraz are known in principle and described, for example, in U.S. Pat. No. 3,991,071 and U.S. Pat. No. 4,080,462, the entire content of which is expressly incorporated herein by way of reference. The acid addition salts of prochloraz can be prepared by reacting prochloraz with an acid of the corresponding acid anion and preferably with hydrochloric acid, hydrobromic acid, sulfuric acid, phosphoric acid or nitric acid.

For short, the binary combination consisting of (a) triticonazole or an agriculturally acceptable salt thereof and (b) prochloraz or an agriculturally acceptable salt thereof is hereinafter referred to as the tripro combination.

To widen the spectrum of action, the tripro combination can also be employed together with other active ingredients which are used in growing the plants described herein, for example together with herbicides, insecticides, nematicides, growth regulators, fungi-cides or else fertilizers. In the present invention, an “active ingredient” is a compound or a combination of compounds which directly exerts a biologically relevant effect, preferably a fungicidal effect as described above.

According to a particular embodiment, the tripro combination of the invention is not used in conjunction with kiralaxyl.

According to a further particular embodiment, the tripro combination of the invention is not used in conjunction with a further fungicide.

According to a further particular embodiment, the tripro combination of the invention is not used in conjunction with a further pesticide.

As used herein, the term “seed” denotes any resting stage of a plant that is physically detached from the vegetative stage of a plant and/or may be stored for prolonged peri-ods of time and/or can be used to re-grow another plant individual of the same species. Here, the term “resting” refers to a state wherein the plant retains viability, within rea-sonable limits, in spite of the absence of light, water and/or nutrients essential for the vegetative (i.e. non-seed) state. In particular, the term refers to true seeds but does not embraces plant propagules such as suckers, corms, bulbs, fruit, tubers, grains, cuttings and cut shoots.

As used herein, the term “plant” means an entire plant or parts thereof, be it genetically modified or not. The term “entire plant” refers to a complete plant individual in its vege-tative, i.e. non-seed stage, characterized by the presence of an arrangement of roots, shoots and foliage, depending on the developmental stage of the plant also flowers and/or fruits, all of which are physically connected to form an individual which is, under reasonable conditions, viable without the need for artificial measures. The term may also refer to an entire plant harvested as such.

The term “plant parts” refers to roots, shoots, foliage, flowers or other parts of the vege-tative stage of the plant, which, when dislodged and disconnected from the rest, are incapable of survival, unless supported by artificial measures or able to re-grow the missing parts to form an entire plant. As used herein, fruits are also considered as plant parts.

As used herein, the term “root” refers to parts of a plant which are normally, in order to fulfill their physiological functions, located beneath the soil surface. Preferably, the term denotes the parts of a plant which are below the seed and have directly emerged from the latter, or from other roots, but not from shoots or foliage.

As used herein, the “shoots and foliage” of a plant are to be understood to be the shoots, stems, branches, leaves and other appendages of the stems and branches of the plant after the seed has sprouted, but not including the roots of the plant. It is preferable that the shoots and foliage of a plant be understood to be those non-root parts of the plant that have grown from the seed and are located a distance of at least one inch away from the seed from which they emerged (outside the region of the seed), and more preferably, to be the non-root parts of the plant that are at or above the sur-face of the soil.

As used herein, “fruits” are considered to be the parts of a plant which contain seeds and/or serve to spread seeds, and/or which may be removed from a plant without impairing its viability.

According to the present invention, the seed treatment comprises applying the active ingredients to a seed. Although the present method can be applied to a seed in any physiological state, it is preferred that the seed be in a sufficiently durable state that it incurs no significant damage during the treatment process. Typically, the seed is a seed that has been harvested from the field; removed from the plant; and/or separated from the fruit and any cob, pod, stalk, outer husk, and surrounding pulp or other non-seed plant material. The seed is preferably also biologically stable to the extent that the treatment would cause no biological damage to the seed. In one embodiment, for ex-ample, the treatment can be applied to seed that has been harvested, cleaned and dried to a moisture content below about 15% by weight. In an alternative embodiment, the seed can be one that has been dried and then primed with water and/or another material and then re-dried before or during the treatment with the active ingredients.

The term seed treatment comprises all suitable seed treatment and especially seed dressing techniques known in the art, such as seed coating (e.g. seed pelleting), seed dusting and seed imbibition (e.g. seed soaking). Here, “seed treatment” refers to all methods that bring seeds and the active ingredients into contact with each other, and “seed dressing” to methods of seed treatment which provide the seeds with an amount of the active ingredients, i.e. which generate a seed comprising the active ingredi-ents. In principle, the treatment can be applied to the seed at any time from the harvest of the seed to the sowing of the seed. The seed can be treated immediately before, or during, the planting of the seed, for example using the “planter's box” method. How-ever, the treatment may also be carried out several weeks or months, for example up to 12 months, before planting the seed, for example in the form of a seed dressing treatment, without a substantially reduced efficacy being observed.

Expediently, the treatment is applied to unsown seed. As used herein, the term “unsown seed” is meant to include seed at any period from the harvest of the seed to the sowing of the seed in the ground for the purpose of germination and growth of the plant.

When it is said that unsown seed is “treated”, such treatment is not meant to include those practices in which the active ingredients are applied to the soil, rather than directly to the seed.

By applying the treatment to the seed prior to the sowing of the seed the operation is simplified. In this manner, seeds can be treated, for example, at a central location and then dispersed for planting. This permits the person who plants the seeds to avoid the handling and use of the active ingredients and to merely handle and plant the treated seeds in a manner that is conventional for regular untreated seeds, which reduces hu-man exposure to the active ingredients.

According to the invention, the seed treatment protects against a phytopathogen selected from the genera Pythium, including but not limited to Pythium ultimum and Pythium debaryanum, and Rhizoctonia, including but not limited to Rhizoctonia solani, which represent harmful fungi. According to a particular aspect, the seed treatment protects against a disease that may be caused by said phytopathogens, including but not limited to, damping-off caused by Rhizoctonia spp, in particular Rhizoctonia solani, and seedling blight caused by Pythium spp, in particular Pythium ultimum and Pythium debaryanum.

One purpose of said seed treatment is to control said phytopathogen. In a particular embodiment of the invention, the treatment protects not only the seed during storage and sowing and up to germination, but also the plants during germination and thereafter, preferably for longer than the emergence phase, particularly preferably for at least six weeks after sowing and again particularly preferably for at least four weeks after sowing.

Such a seed treatment thus involves a fungicidal effect or a fungicidal activity providing protection against damage done by said fungi to a seed and/or a plant grown from the seed.

As used herein, the terms “fungicidal effect” and “fungicidal activity” mean any direct or indirect action on the target fungus that results in reduction of damage on the treated seeds as well as on the plants or their parts (fruits, roots, shoots and/or foliage) grown from treated seeds of as compared untreated seeds or to plants grown from untreated seeds, respectively. The term “active against a fungus” also has the same meaning. Such direct or indirect actions include killing the fungus, and inhibiting or preventing reproduction of the fungus.

In each embodiment of the invention, it is preferred that the active ingredients are applied to a seed in an effective amount, that is, an amount sufficient to provide protection against the fungus to the seed and/or the plant that grows from the seed. As used herein, “protection” is to be understood as meaning any measure or combination of measures which is suitable to reduce or completely prevent damage by said fungus. Here, “damage” includes any kind of qualitative and/or quantitative yield reduction (reduction of the number of germinating plants, the harvest yield, the fruit quality, etc.). Protection is to be considered as having been achieved when the damage of the treated seed and/or the plants grown therefrom is significantly reduced compared to that of the untreated seed and/or the plants grown therefrom. In order to be effective, the active ingredients are generally employed in an amount of from 1 to 500 g, preferably 10 to 200 g, per 100 kilograms of seed.

Surprisingly, the tripro combination according to the invention has a better fungicidal activity against the harmful fungi than would have been expected based on the fungicidal activity of the individual compounds, i.e. the fungicidal activity is increased in a superadditive manner. This means that, by using the tripro combination, an enhanced activity against harmful fungi in the sense of a synergetic effect (synergism) is achieved. For this reason, the combinations may be employed at lower total application rates.

According to the invention, the tripro combination comprises triticonazole or an agriculturally acceptable salt thereof and prochloraz or an agriculturally acceptable salt thereof in a weight ratio of usually from 200:1 to 1:200, more preferably from 100:1 to 1:100, particularly preferably from 50:1 to 1:50 and especially from 10:1 to 1:10. Preferably, the weight ratio is such that a synergistic effect takes place when the combination is applied.

There are particular advantages with respect to the protection of the following host plants:
lawn grasses, rice, corn, cotton, oilseed rape, sunflowers, sugarbeet, soybean or vegetables if the phytopathogen is a Pythium species,
cotton, rice, potatoes, lawn grasses, corn, oilseed rape, sugarbeet, soybean or vegetables if the phytopathogen is a Rhizoctonia species.

According to a particular embodiment, the invention relates to the treatment of seed from oilseed rape to provide protection against a Pythium species, in particular Pythium ultimum.

According to a further particular embodiment, the invention relates to the treatment of seed from sugarbeet to provide protection against a Pythium species, in particular Pythium ultimum.

According to a further particular embodiment, the invention relates to the treatment of seed from oilseed rape to provide protection against a Rhizoctonia species, in particular Rhizoctonia solani.

According to a further particular embodiment, the invention relates to the treatment of seed from sugarbeet to provide protection against a Rhizoctonia solani.

Triticonazole or an agriculturally acceptable salt thereof and prochloraz or an agriculturally acceptable salt thereof can be applied jointly or separately. In the case of separate application, the application of the individual active substances can be simultaneously or—as part of a treatment sequence—one after the other, where the application in the case of successive application is preferably carried out at an interval of from a few minutes to a number of days.

Thus, the present invention also relates to agents such as 1) compositions comprising (a) triticonazole or an agriculturally acceptable salt thereof and (b) prochloraz or an agriculturally acceptable salt thereof, as well as 2) kits comprising a first component which comprises triticonazole or an agriculturally acceptable salt thereof and at least one further component which comprises prochloraz or an agriculturally acceptable salt thereof, where the first and the further component are generally present in the form of separate formulations.

If the tripro combination is employed jointly with a further pesticidal active ingredient, the latter can be applied simultaneously with the tripro combination or after a short time interval, for example within a few days before or after the tripro combination treatment. In the case of simultaneous application, the treatment of the seed can be effected in one pass where a composition comprising the tripro combination and the further fungicidal active ingredient are applied, or else in separate passes where different compositions of the individual active ingredients are applied.

The active ingredient concentrations in ready-to-use preparations can be varied within substantial ranges. In general, they are in the range from 0.01 and 80% by weight, frequently in the range from 0.1 to 50% by weight, preferably in the range from 0.5 and 20% by weight, based on the total weight of the preparation. The active ingredients can also successfully be used in concentrated form, it being possible to apply to the seed preparations with more than 80% by weight of active ingredient, or even the active ingredient without additions.

In principle, all customary methods of treating and in particular dressing such as coating (e.g. pelleting) and imbibing (e.g. soaking) seeds can be employed. Specifically, the seed treatment follows a procedure in which the seed is exposed to the specifically desired amount of a preparation comprising the active ingredients. The preparation may be a formulation that is applied as such or after previously diluting it, e.g. with wa-ter; for instance, it may be expedient to dilute seed treatment formulations 2-10 fold leading to concentrations in the ready-to-use compositions of 0.01 to 60% by weight of the active ingredients, preferably 0.1 to 40% by weight. Usually, a device which is suit-able for this purpose, for example a mixer for solid or solid/liquid components, is employed until the preparation is distributed uniformly on the seed. Thus, the preparation can be applied to seeds by any standard seed treatment methodology, including but not limited to mixing in a container (e.g., a bottle, bag or tumbler), mechanical application, tumbling, spraying, and immersion. If appropriate, this is followed by drying.

Particular embodiments of the present invention comprise seed coating and imbibition (e.g. soaking). “Coating” denotes any process that endows the outer surfaces of the seeds partially or completely with a layer or layers of non-plant material, and “imbibition” any process that results in penetration of the active ingredient(s) into the germinable parts of the seed and/or its natural sheath, (inner) husk, hull, shell, pod and/or integument. The invention therefore also relates to a treatment of seeds which comprises providing seeds with a coating that comprises the active ingredients, and to a treatment of seeds which comprises imbibition of seeds with the active ingredients.

Coating is particularly effective in accommodating high loads of the active ingredients, as may be required to treat typically refractory arthropod pests, while at the same time preventing unacceptable phytotoxicity due to the increased load of the active ingredi-ents.

Coating may be applied to the seeds using conventional coating techniques and ma-chines, such as fluidized bed techniques, the roller mill method, rotostatic seed treat-ers, and drum coaters. Other methods such as the spouted beds technique may also be useful. The seeds may be pre-sized before coating. After coating, the seeds are typically dried and then transferred to a sizing machine for sizing.

Such procedures are known in the art. Seed coating methods and apparatus for their application are disclosed in, for example, U.S. Pat. Nos. 5,918,413, 5,891,246, 5,554,445, 5,389,399, 5,107,787, 5,080,925, 4,759,945 and 4,465,017.

In another particular embodiment, the active ingredients, for instance as a solid fine particulate formulation, e.g. a powder or dust, can be mixed directly with seeds. Optionally, a sticking agent can be used to effect adherence of the solid, e.g. the powder, to the seed surface. For example, a quantity of seed can be mixed with a sticking agent (which increases adhesion of the particles on the surface of the seed) and optionally agitated to encourage uniform coating of the seed with the sticking agent. For example, the seed can be mixed with a sufficient amount of sticking agent, which leads to a partial or complete coating of the seed with sticking agent. The seed pretreated in this way is then mixed with a solid formulation containing the active ingredients to achieve adhesion of the solid formulation on the surface of the seed material. The mixture can be agitated, for example by tumbling, to encourage contact of the sticking agent with the active ingredients, thereby causing the active ingredients to stick to the seed.

Another particular method of treating seed with the active ingredients is imbibition. For example, seed can be combined for a period of time with an aqueous solution comprising from about 1% by weight to about 75% by weight of the active ingredients in a sol-vent such as water. Preferably the concentration of the solution is from about 5% by weight to about 50% by weight, more preferably from about 10% by weight to about 25% by weight. During the period that the seed is combined with the solution, the seed takes up (imbibes) at least a portion of the active ingredients. Optionally, the mixture of seed and solution can be agitated, for example by shaking, rolling, tumbling, or other means. After the imbibition process, the seed can be separated from the solution and optionally dried in a suitable manner, for example by patting or air-drying.

In yet another particular embodiment of the present invention, the active ingredients can be introduced onto or into a seed by use of solid matrix priming. For example, a quantity of the active ingredients can be mixed with a solid matrix material, and then the seed can be placed into contact with the solid matrix material for a period to allow the active ingredients to be introduced to the seed. The seed can then optionally be separated from the solid matrix material and stored or used, or, preferably, the mixture of solid matrix material plus seed can be stored or planted/sown directly.

As described above, the active ingredients and optionally the further active ingredi-ent(s) can be used as such, that is, without any auxiliary agents present. However, the active ingredients and the further active ingredient(s) are typically applied to the seeds in the form of a composition.

As used herein, ingredients comprise active ingredients and auxiliary agents. A “composition” comprises at least one active ingredient and at least one auxiliary agent.

The term “auxiliary agent” refers to a compound or combination of compounds which do not exert a biologically relevant effect of their own, but support the effects of the active ingredient(s). When auxiliary agents are used, their choice will depend on the active ingredients and on the procedures selected for seed treatment.

Usually, the compositions thus comprise an active ingredient component (“A”) and an auxiliary agent component (“B”). The active ingredient component (“A”) of the composition comprises the tripro combination (“A1”) and optionally one or more further active ingredient(s) (“A2”). The auxiliary agent component (“B”) comprises one or more auxiliary agent(s).

In general, the compositions comprise from 0.005% by weight to 95% by weight, preferably from 0.1% by weight to 90% by weight, in particular from 5% by weight to 50% by weight, of the active ingredient component “A”, the balance being formed by component “B”. In this context, the active ingredients are employed in a purity of 90% to 100%, preferably 95% to 100% (according to NMR spectrum). According to a particular embodiment, component “A” essentially consists of the tripro combination, i.e. the active ingredient of the composition is the tripro combination.

In a particular embodiment of the invention, the composition may additionally comprise one or more repellents for warm-blooded animals, e.g. birds, dogs and hedgehogs, for example nonanoic acid vanillyl amide. The amount of repellent will preferably range from 0.1 to 5% by weight, based on the total weight of the composition.

According to a particular embodiment, the composition is a seed treatment formulation. A seed treatment formulation according to the present invention comprises at least one auxiliary agent that is specifically suited for seed treatment, i.e. an auxiliary agent which in particular promotes adhesion of the active ingredients to and/or penetration into the seeds and/or otherwise improves stability and/or manageability of the composition or the seeds treated therewith. Thus, the present invention also relates to a seed treatment formulation, which comprises the active ingredients, at least one seed treat-ment auxiliary agent(s), and optionally one or more further auxiliary agents.

In particular, seed treatment auxiliary agents are selected from the group consisting of agents suitable for seed coating coating materials, agents suitable for solid matrix priming materials, penetration enhancers suitable for promoting seed imbibition, colorants, antifreezes, and gelling agents.

According to a preferred embodiment, the seed coating material comprises a binder (or sticker). Optionally, the coating material also comprises one or more additional seed treatment auxiliary agents selected from the group consisting of fillers and plasticizers.

Binders (or stickers) are all customary binders (or stickers) which can be employed in seed treatment formulations. Binders (or stickers) that are useful in the present inven-tion preferably comprise an adhesive polymer that may be natural or partly or wholly synthetic and is without phytotoxic effect on the seed to be coated. Preferably, the binder (or sticker) is biodegradable. Preferably the binder or sticker is chosen to act as a matrix for the active ingredients.

The binder (or sticker) may be selected from polyesters, polyether esters, polyanhydrides, polyester urethanes, polyester amides; polyvinyl acetates; polyvinyl acetate copolymers; polyvinyl alcohols and tylose; polyvinyl alcohol copolymers; polyvinylpyrolidones; polysaccharides, including starches, modified starches and starch derivatives, dextrins, maltodextrins, alginates, chitosanes and celluloses, cellulose esters, cellulose ethers and cellulose ether esters including ethylcelluloses, methylcelluloses, hydroxymethylcelluloses, hydroxypropylcelluloses and carboxymethylcellulose; fats; oils; proteins, including casein, gelatin and zeins; gum arabics; shellacs; vinylidene chloride and vinylidene chloride copolymers; lignosulfonates, in particular calcium lig-nosulfonates; polyacrylates, polymethacrylates and acrylic copolymers; polyvinylacry-lates; polyethylene oxide; polybutenes, polyisobutenes, polystyrene, polyethylene-amines, polyethylenamides; acrylamide polymers and copolymers; polyhydroxyethyl acrylate, methylacrylamide monomers; and polychloroprene. In a particular embodiment, the binder is a thermoplastic polymer.

In a particular embodiment of the invention the seed treatment formulation contains at least one polyester, which, in particular, is selected from polylactides, partially aromatic polyesters (copolymers of terephthalic acid, adipic acid and aliphatic diols), polygly-colides, polyhydroxyalkanoates and polytartrates.

The amount of binder (or sticker) in the formulation can vary, but will be in the range of about 0.01 to about 25% of the total weight, more preferably from about 1 to about 15%, and even more preferably from about 5% to about 10%.

As mentioned above, the coating material can optionally also comprise a filler. The filler can be an absorbent or an inert filler, such as are known in the art, and may include wood flours, cereal flours, tree bark mill, wood meal and nut shell meal, sugars, in par-ticular polysaccharides, activated carbon, fine-grain inorganic solids, silica gels, silicates, clays, chalk, diatomaceous earth, calcium carbonate, magnesium carbonate, dolomite, magnesium oxide, calcium sulfate and the like. Clays and inorganic solids which may be used include calcium bentonite, kaolin, china clay, talc, perlite, mica, vermiculite, silicates, quartz powder, montmorillonite, attapulgite, bole, loess, lime-stone, lime and mixtures thereof. Sugars which may be useful include dextrin and maltodextrin. Cereal flours include wheat flour, oat flour and barley flour. The filler may also comprise fertilizer substances such as, for example, ammonium sulfate, ammonium phosphate, ammonium nitrate, ureas and mixtures thereof.

The filler is selected so that it will provide a proper microclimate for the seed, for exam-ple the filler is used to increase the loading rate of the active ingredients and to adjust the control-release of the active ingredients. The filler can aid in the production or process of coating the seed. The amount of filler can vary, but generally the weight of the filler components will be in the range of about 0.05 to about 75% of the total weight, more preferably about 0.1 to about 50%, and even more preferably about 0.5% to 15%.

It is preferred that the binder (or sticker) be selected so that it can serve as a matrix for the active ingredients. While the binders disclosed above may all be useful as a matrix, it is preferred that a continuous solid phase of one or more binder compounds is formed throughout which is distributed as a discontinuous phase the active ingredients. Optionally, a filler and/or other components can also be present in the matrix. The term “matrix” is to be understood to include what may be viewed as a matrix system, a reservoir system or a microencapsulated system. In general, a matrix system consists of the active ingredients and a filler uniformly dispersed within a polymer, while a reservoir system consists of a separate phase comprising the active ingredients that is physically dispersed within a surrounding, rate-limiting, polymeric phase. Microencapsulation includes the coating of small particles or droplets of liquid, but also to dispersions in a solid matrix.

Especially if the active ingredients used in the coating is an oily type composition and little or no inert filler is present, it may be useful to hasten the drying process by drying the composition. This optional step may be accomplished by means well known in the art and can include the addition of calcium carbonate, kaolin or bentonite clay, perlite, diatomaceous earth, or any absorbent material that is added preferably concurrently with the active ingredients coating layer to absorb the oil or excess moisture. The amount of absorbent necessary to effectively provide a dry coating will be in the range of about 0.5 to about 10% of the weight of the seed.

Optionally, the coating material comprises a plasticizer. Plasticizers are typically used to make the film that is formed by the coating layer more flexible, to improve adhesion and spreadability, and to improve the speed of processing. Improved film flexibility is important to minimize chipping, breakage or flaking during storage, handling or sowing processes. Various plasticizers may be used; however, useful plasticizers include poly-ethylene glycol, oligomeric polyalkylene glycols, glycerol, alkylbenzylphthalates, in par-ticular butylbenzylphthalate, glycol benzoates and related compounds. The range of plasticizer in the coating layer will be in the range of from about 0.1% by weight to about 20% by weight.

Agents suitable for solid matrix priming materials which are useful in the present inven-tion include polyacrylamide, starch, clay, silica, alumina, soil, sand, polyurea, polyacrylate, or any other material capable of absorbing or adsorbing the active ingredients for a time and releasing that the active ingredients into or onto the seed. It is useful to make sure that the active ingredients and the solid matrix material are compatible with each other. For example, the solid matrix material should be chosen so that it can re-lease the active ingredients at a reasonable rate, for example over a period of minutes, hours, or days.

Penetration enhancers suitable for promoting seed imbibition include agriculturally acceptable surface active compounds. The amount of penetration enhancers will usually not exceed 20% by weight, based on the total weight of the formulation. Preferably, the amount of penetration enhancers will be in the range from 2% to 20% by weight.

Colorants according to the invention are all dyes and pigments which are customary for such purposes. In this context, both pigments, which are sparingly soluble in water, and dyes, which are soluble in water, may be used. Examples which may be mentioned are the colorants, dyes and pigments known under the names Rhodamin B, C. I. Pigment Red 112 and C. I. Solvent Red 1, Pigment Blue 15:4, Pigment Blue 15:3, Pigment Blue 15:2, Pigment Blue 15:1, Pigment Blue 80, Pigment Yellow 1, Pigment Yellow 13, Pigment Red 48:2, Pigment Red 48:1, Pigment Red 57:1, Pigment Red 53:1, Pigment Orange 43, Pigment Orange 34, Pigment Orange 5, Pigment Green 36, Pigment Green 7, Pigment White 6, Pigment Brown 25, Basic Violet 10, Basic Violet 49, Acid Red 51, Acid Red 52, Acid Red 14, Acid Blue 9, Acid Yellow 23, Basic Red 10, Basic Red 108. The amount of colorants will usually not exceed 20% by weight of the formulation and preferably ranges from 1 to 15% by weight, based on the total weight of the formula-tion. It is generally preferred if the colorants are also active as repellents for warm-blooded animals, e.g. iron oxide, TiO₂, Prussian blue, anthraquinone dyes, azo dyes and metal phtalocyanine dyes.

Antifreezes which can be employed especially for aqueous formulations are in principle all those substances which lead to a depression of the melting point of water. Suitable antifreezes comprise alcohols such as methanol, ethanol, isopropanol, butanols, glycol, glycerine, diethylenglycol and the like. Typically, the amount of antifreeze will not ex-ceed 20% by weight and frequently ranges from 1 to 15% by weight, based on the total weight of the formulation.

Gelling agents which are suitable are all substances which can be employed for such purposes in agrochemical compositions, for example cellulose derivatives, polyacrylic acid derivatives, xanthan, modified clays, in particular organically modified phyllosili-cates and highly-dispersed silicates. A particularly suitable gelling agent is carrageen (Satiagel®). Usually, the amount of gelling agent will not exceed 5% by weight of the formulation and preferably ranges from 0.5 to 5% by weight, based on the total weight of the formulation.

Further auxiliary agents that may be present in the seed treatment formulation include solvents, wetters, dispersants, emulsifiers, surfactants, stabilizers, protective colloids, antifoams, and preservatives.

Examples of suitable solvents are water or organic solvents such as aromatic solvents (for example Solvesso products, xylene), paraffins (for example mineral oil fractions), alcohols (for example methanol, butanol, pentanol, benzyl alcohol), ketones (for exam-ple cyclohexanone, gamma-butyrolactone), pyrrolidones (NMP, NOP), acetates (glycol diacetate), glycols, fatty acid dimethylamides, fatty acids and fatty acid esters. In principle, solvent mixtures may also be used. However, according to a particular embodiment, the formulations of the present invention contain less than 10% by weight and preferably less than 6% by weight of said organic solvents.

Surface active compounds are all those surfactants which are suitable for formulating agrochemical actives, in particular for the active ingredients, and which may be non-ionic, cationic, anionic or amphoteric. According to their action, surfactants—sometimes referred to as “additives”—may be divided into wetters, dispersants, emulsifiers or protective colloids; however, these particular groups may overlap and cannot be divided strictly. Typically, the amount of surfactants will not exceed 20% by weight and frequently ranges from 1 to 15% by weight, based on the total weight of the formula-tion.

Suitable wetters are all those substances which promote wetting and which are conventionally used for formulating agrochemical active ingredients. Alkylnaphthalenesulfonates such as diisopropyl- or diisobutylnaphthalenesulfonates can be used preferably.

Dispersants and/or emulsifiers which are suitable are all nonionic, anionic and cationic dispersants or emulsifiers conventionally used for formulating agrochemical active ingredients. The following can preferably be used: nonionic or anionic dispersants and/or emulsifiers or mixtures of nonionic or anionic dispersants and/or emulsifiers.

Suitable nonionic dispersants and/or emulsifiers which may be employed are, in par-ticular, ethylene oxide/alkylene oxide block copolymers, alkylphenol polyglycol ethers and tristryrylphenol polyglycol ethers, for example polyoxyethylene octylphenol ether, ethoxylated isooctylphenol, octylphenol, nonylphenol, alkylphenol polyglycol ether, tributylphenyl polyglycol ether, tristearylphenyl polyglycol ether, alkylarylpolyether alco-hols, alcohol and fatty alcohol ethylene oxide condensates, ethoxylated castor oil, polyoxyethylene alkyl ether, ethoxylated polyoxypropylene, lauryl alcohol polyglycol ether acetal, sorbitol esters and methyl cellulose. However, according to a particular embodiment, the formulations of the present invention contain less than 10% by weight and preferably less than 6% by weight of ethylene oxide/alkylene oxide block copolymer, and, more particularly, less than 10% by weight and preferably less than 6% by weight of said nonionic dispersants and/or emulsifiers.

Suitable anionic dispersants which and/or emulsifiers which may be employed are, in particular, alkali metal, alkaline earth metal and ammonium salts of ligninsulfonic acid, naphthalenesulfonic acid, phenolsulfonic acid, dibutylnaphthalenesulfonic acid, alky-larylsulfonates, alkyl sulfates, alkylsulfonates, fatty alcohol sulfates, fatty acids and sulfated fatty alcohol glycol ethers, furthermore arylsulfonate/formaldehyde condensates, for example condensates of sulfonated naphthalene and naphthalene derivatives with formaldehyde, condensates of naphthalene or of naphthalenesulfonic acid with phenol and formaldehyde, ligninsulfonates, lignin-sulfite waste liquors, phosphated or sulfated derivatives of methylcellulose, and salts of polyacrylic acid.

Protective colloids are typically water soluble, amphiphilic polymers. Examples include proteins and denatured proteins such as casein, polysaccharides such as water soluble starch derivatives and cellulose derivatives, in particular hydrophobic modified starch and celluloses, furthermore polycarboxylates such as polyacrylic acid and acrylic acid copolymers, polyvinylalcohol, polyvinylpyrrolidone, vinylpyrrolidone copolymers, polyvinyl amines, polyethylene imines and polyalkylene ethers.

Antifoams which can be employed are all those substances which inhibit the develop-ment of foam and which are conventionally used for formulating agrochemical active ingredients. Silicone antifoams, i.e. aqueous silicon emulsions (e.g. Silikon® SRE by Wacker or Rhodorsil® by Rhodia), long chain alcohols, fatty acids and salts thereof, e.g. magnesium stearate are particularly suitable. Usually, the amount of antifoam will not exceed 3% by weight of the formulation and preferably ranges from 0.1 to 2% by weight, based on the total weight of the formulation.

Preservatives which can be employed are all preservatives used for such purposes in agrochemical compositions. Examples which may be mentioned are dichlorophene, isothiazolenes and isothiazolones such as 1,2-benzisothiazol-3(2H)-one, 2-methyl-2H-isothiazol-3-one-hydrochloride, 5-chloro-2-(4-chlorobenzyl)-3(2H)-isothiazolone, 5-chloro-2-methyl-2H-isothiazol-3-one, 5-chloro-2-methyl-2H-isothiazol-3-one, 5-chloro-2-methyl-2H-isothiazol-3-one-hydrochloride, 4,5-dichloro-2-cyclohexyl-4-isothiazolin-3-one, 4,5-dichloro-2-octyl-2H-isothiazol-3-one, 2-methyl-2H-isothiazol-3-one, 2-methyl-2H-isothiazol-3-one-calcium chloride complex, 2-octyl-2H-isothiazol-3-one and benzyl alcohol hemiformal. Usually, the amount of preservatives will not exceed 2% by weight of the formulation and preferably ranges from 0.01 to 1% by weight, based on the total weight of the formulation.

The skilled person is essentially familiar with agricultural compositions of active ingre-dients. Examples include water-soluble concentrates (SL, LS), dispersible concentrates (DC), emulsifiable concentrates (EC), emulsions (EW, EO, ES), suspensions (SC, OD, FS), water-dispersible granules (WG, SG), water-dispersible or water-soluble powders (WP, SP, SS, WS), dusts or dustable powders (DP, DS), granules (GR, FG, GG, MG), ULV solutions (UL) and gel formulations (GF). The skilled worker is familiar with such compositions, for example from Ullmann's Encyclopedia of Industrial Chemistry, Fungi-cides Chapter 4, 5th ed. on CD-ROM, Wiley-VCH, 1997 and Mollet, H., Grubemann, A., Formulation technology, Wiley VCH Verlag GmbH, Weinheim (Federal Republic of Germany), 2001.

For seed treatment purposes, such compositions may be applied as such or after addition of a suitable liquid, in particular water, in order to dissolve, emulsify, disperse, suspend or dilute the composition. The type of the ready-to-use preparation applied to the seeds thus depends on the type of composition used and the method used for treating the seeds.

Such compositions can be prepared in the known manner (see e.g. for review U.S. Pat. No. 3,060,084, EP-A 707 445 (for liquid concentrates), Browning, “Agglomeration”, Chemi-cal Engineering, Dec. 4, 1967, 147-48, Perry's Chemical Engineer's Handbook, 4th Ed., McGraw-Hill, New York, 1963, pages 8-57 and et seq. WO 91/13546, U.S. Pat. No. 4,172,714, U.S. Pat. No. 4,144,050, U.S. Pat. No. 3,920,442, U.S. Pat. No. 5,180,587, U.S. Pat. No. 5,232,701, U.S. Pat. No. 5,208,030, GB 2,095,558, U.S. Pat. No. 3,299,566, Klingman, Weed Control as a Science, John Wiley and Sons, Inc., New York, 1961, Hance et al., Weed Control Handbook, 8th Ed., Blackwell Scientific Publications, Oxford, 1989 and Mollet, H., Grubemann, A., Formulation tech-nology, Wiley VCH Verlag GmbH, Weinheim (Germany), 2001, 2. D. A. Knowles, Chemistry and Technology of Agrochemical Formulations, Kluwer Academic Publish-ers, Dordrecht, 1998 (ISBN 0-7514-0443-8)), for example by extending the active ingredient component with one or more auxiliary agents.

The following examples simply illustrate said compositions:

### A Water-Soluble Concentrates, Solutions (SL, LS)

10 parts by weight of the active ingredients are dissolved in 90 parts by weight of water or a water-soluble solvent. As an alternative, wetters or other auxiliaries are added to the active ingredients. The active ingredients dissolves upon dilution with water.

### B Dispersible Concentrates (DC)

20 parts by weight of the active ingredients are dissolved in 70 parts by weight of cyclohexanone with addition of 10 parts by weight of a dispersant, for example polyvinylpyrrolidone. Dilution with water gives a dispersion.

### C Emulsifiable Concentrates (EC)

15 parts by weight of the active ingredients are dissolved in 7 parts by weight of xylene with addition of calcium dodecylbenzenesulfonate and castor oil ethoxylate (in each case 5 parts by weight). Dilution with water gives an emulsion.

### D Emulsions (EW, EO, ES)

25 parts by weight of the active ingredients are dissolved in 35 parts by weight of xy-lene with addition of calcium dodecylbenzenesulfonate and castor oil ethoxylate (in each case 5 parts by weight). This mixture is introduced into 30 parts by weight of wa-ter by means of an emulsifier machine (e.g. Ultraturrax) and made into a homogeneous emulsion. Dilution with water gives an emulsion.

### E Suspensions (SC, OD, FS)

In an agitated ball mill, 20 parts by weight of the active ingredients are comminuted with addition of 10 parts by weight of dispersants, wetters and 70 parts by weight of water or of an organic solvent to give a fine active compound(s) suspension. Dilution with water gives a stable suspension of the active ingredients, whereby a formula-tion with 20% (w/w) of the active ingredients is obtained.

### F Water-Dispersible Granules (WG, SG)

50 parts by weight of the active ingredients are ground finely with addition of 50 parts by weight of dispersants and wetters and made as water-dispersible or water-soluble granules by means of technical appliances (for example extrusion, spray tower, fluidized bed). Dilution with water gives a stable dispersion or solution of the active compound(s).

### G Water-Dispersible and Water-Soluble Powders (WP, SP, SS, WS)

75 parts by weight of the active ingredients re ground in a rotor-stator mill with addition of 25 parts by weight of dispersants, wetters and silica gel. Dilution with water gives a stable dispersion or solution of the active ingredients.

### H Dusts and Dustable Powders (DP, DS)

5 parts by weight of the active ingredients are ground finely and mixed intimately with 95 parts by weight of finely divided kaolin. This gives a dustable product.

### I Granules (GR, FG, GG, MG),

0.5 part by weight of the active ingredients is ground finely and associated with 95.5 parts by weight of carriers. Current methods are extrusion, spray-drying or the fluidized bed.

### J ULV Solutions (UL)

10 parts by weight of the active ingredients are dissolved in 90 parts by weight of an organic solvent, for example xylene. This gives a product having 10% (w/w) of the active ingredients.

### K Gel Formulations (GF)

In an agitated ball mill, 20 parts by weight of the active ingredients are comminuted with addition of 10 parts by weight of dispersants, 1 part by weight of a gelling agent wetters and 70 parts by weight of water or of an organic solvent to give a fine active compound(s) suspension. Dilution with water gives a stable suspension of the active ingredients.

For the seed treatment according to the present invention, powders, such as water-dispersible, water-soluble and dustable powders, dusts and suspensions are preferred. Further, gel formulations are preferred. Also, water-soluble concentrates and emulsions may be expediently used.

According to the present invention, the following formulations are particularly preferred: flowable concentrates (especially FS); solutions (especially LS); powders for dry treatment (especially DS); water dispersible powders for slurry treatment (especially WS); water-soluble powders (especially SS) and emulsions (especially ES). Also preferred are gel formulations (especially GF). These formulations can be applied to the seed diluted or undiluted.

According to a particular embodiment, a FS formulation is used for seed treatment. Typically, a FS formulation may comprise 1 to 800 g/l of the active ingredients, 1 to 200 g/l surfactant, 0 to 200 g/l antifreezing agent, 0 to 400 g/l of binder, 0 to 200 g/l of a colorant and up to 1 liter of a solvent, preferably water.

According to a further particular embodiment, the seed treatment formulation of the present invention is a seed coating formulation.

Such seed coating formulations comprise the active ingredients, at least one binder (or sticker) and optionally at least one further auxiliary agent that is selected from the group consisting of fillers and plasticizers.

Seed coating formulations comprising binders, fillers and/or plasticizers are well-known in the art. Seed coating formulations are disclosed, for example, in U.S. Pat. Nos. 5,939,356, 5,882,713, 5,876,739, 5,849,320, 5,834,447, 5,791,084, 5,661,103, 5,622,003, 5,580,544, 5,328,942, 5,300,127, 4,735,015, 4,634,587, 4,383,391, 4,372,080, 4,339,456, 4,272,417 and 4,245,432, among others.

The amount of the active ingredients that is included in the coating formulation will vary depending upon the type of seed, but the coating formulation will contain an amount of the active ingredients that is fungicidally effective. In general, the amount of the active ingredients in the coating formulation will range from about 0.005 to about 75% of the total weight. A more preferred range for the active ingredients is from about 0.01 to about 40%; more preferred is from about 0.05 to about 20%.

The exact amount of the active ingredients that is included in the coating formulation is easily determined by one skilled in the art and will vary depending upon the size and other characteristics (surface structure etc.) of the seed to be coated. The active ingre-dients of the coating formulation must not inhibit germination of the seed and should be efficacious in protecting the seed and/or the plant during that time in the target insect's life cycle in which it causes injury to the seed or plant. In general, the coating will be efficacious for approximately 0 to 120 days, preferably for approximately 0 to 60 days, after sowing.

The coating formulations formed with the active ingredients are capable of effecting a slow rate of release of the active ingredients by diffusion or movement through the matrix into the seed or to the surrounding medium.

The present invention also provides a seed that has been treated by the method de-scribed above. It also provides a seed obtainable by the method described above.

Further, the present invention also provides a seed that has been treated with the seed treatment formulation described above, and in particular a seed that is coated with the formulation or contains it. It also provides a seed obtainable by using the formulation described above.

The term “coated with and/or contains” here signifies that the active ingredients is for the most part on the surface of the seed at the time of application, although a greater or lesser part of the active ingredients may penetrate into the seed, depending on the method of application. When the said seed is (re)planted, it may absorb the active ingredients.

Still further, the present invention relates to a seed, especially an unsown seed, which comprises the active ingredients.

According to one embodiment, such a seed comprising the active ingredients has a coating, wherein the coating comprises the active ingredients. According to a further embodiment, such a seed comprising the active ingredients is a seed whose germinable part and/or natural sheath, shell, pod and/or integument comprise(s) the active ingredients. Also, the active ingredients can be present in both the coating and the germinable part and/or natural sheath, shell, pod and/or integument of the seed.

Preferably, such seeds comprise an effective amount of the active ingredients. Accordingly, the seeds are coated, impregnated or coated and impregnated in such a manner that pest damage during germination and emergence is reduced.

The seeds treated with the active ingredients may also be enveloped with a film over-coating to protect the active ingredient coating. Such overcoatings are known in the art and may be applied using conventional fluidized bed and drum film coating techniques.

The seeds of the present invention can be used for the propagation of plants. The seeds can be stored, handled, planted/sowed and tilled.

Unless indicated otherwise, all amounts in % by weight refer to the weight of the total composition (or formulation).

The invention will be illustrated by the following examples, which should not be construed as limiting the invention.

### EXAMPLES

### 1. Preparation Example

### 1.1 Preparation of R-Triticonazole:

1.1.1 Preparation of 2-(4-chlorobenzylidene)-5,5-dimethyl-1-(dimethylammonium-methyl)-1-cyclopentanol chloride:

5.97 kg (24 mol) of the epoxide of the formula

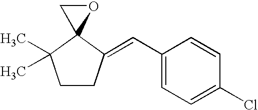

are mixed with 3.251 (28.8 mol) of dimethylamine and 3.2 l of n-butanol. The reaction mixture is heated at 80° C. for 4 h, and evaporated dimethylamine is condensed using an acetone/dry-ice condenser and returned to the reaction mixture. After cooling over-night, 2.5 l of concentrated hydrochloric acid are added to the mixture until a pH of 2 is reached. Overnight, a white precipitate is formed, which is filtered off, washed with toluene and dried in a stream of air. This gives 7.1 kg (90% of theory) of the title compound in the form of a white solid.
1.1.2 Preparation of 2-(4-chlorobenzylidene)-5,5-dimethyl-1-(dimethylaminomethyl)-1-cyclopentanol:

4.4 kg (13.3 mol) of the product from example 1.1.1 are suspended in 10 l of water, and 1.8 l of a 30% strength aqueous sodium hydroxide solution are added. The precipitate formed is filtered off, washed with water and dried in a stream of air. This gives 3.7 kg (95% of theory) of the title compound in the form of a slightly yellow solid.

Purity (¹H-NMR (250 MHz, CDCl₃)): >95%

### 1.1.3 Racemate Resolution:

1.88 kg (12.6 mol) of D-(−)-tartaric acid are added in one portion to a solution of 3.69 kg (12.6 mol) of the amine obtained in example 1.1.2 in 40 l of acetone, resulting in an increase of the internal temperature of from 18° C. to 24° C. over a period of 5 min. After 10 min, a white solid has formed, which is filtered off and dried. This solid is recrystallized in 12 l of boiling ethanol. After cooling to 20° C., the white crystals formed are filtered off and dried in a stream of air overnight. This gives 2.74 kg (98% of theory) of the D-(−)-tartrate of the R enantiomer in the form of a white solid. This has an optical purity, determined by optical rotation, of >99% ee.

1.1.4 Preparation of R-(4-chlorobenzylidene)-5,5-dimethyl-1-(dimethylaminomethyl)-1-cyclopentanol:

A 30% strength aqueous sodium hydroxide solution is added to a suspension of 2.34 kg (53 mol) of the product obtained in example 1.1.3 in 15 l of water such that the pH increases from 3 to 14. A dense white precipitate is formed, and the reaction medium becomes highly viscous. The mixture is filtered and the solid is repeatedly washed with water and dried. This gives 2.1 kg of the title compound which still contains water.

1.1.5 Preparation of R-(4-chlorobenzylidene)-5,5-dimethyl-1-(1H-1,2,4-triazol-1-ylmethyl)-1-cyclopentanol:

2.1 kg of the amine obtained in example 1.1.4 are dissolved in 5.3 l of N-methylpyrrolidone, and 360 ml (5.8 mol) of methyl iodide are added over a period of 10 min. The temperature increases from 25 to 53° C., and the color of the solution turns dark. After 2 h, the temperature is back at 25° C., and 509 g of a 50% strength aqueous sodium hydroxide solution are added to the reaction mixture over a period of 5 min. The temperature increases from 25 to 37° C., and the color of the solution becomes light. 401 g (5.8 mol) of 1H-[1,2,4]-triazole are then added in one portion, and the temperature increases to 42° C. The mixture is heated at 80° C. At about 55° C., a slow and uniform evolution of gas sets in. The reaction mixture is kept at 80° C. overnight. To re-move any ammonium salt still present, 84 g of a 50% strength sodium hydroxide solution are added to the reaction mixture, causing the evolution of gas to recommence. After 2 h, the mixture is cooled to 50° C. and transferred into a mixture of 15 l of water and 5 l of ethyl acetate. The aqueous phase is extracted with 5 l of ethyl acetate. The combined organic phases are washed with 2×10 l of water and then freed from the solvent. This gives 1.7 kg of a solid which is initially purified by column chromatography on silica gel using the mobile phase methylene chloride/acetone (90/10). The product obtained is then recrystallized in 3 l of boiling methanol. After cooling to 5° C., the solid formed is filtered, washed with 2 l of ice-cold methanol and dried at 70° C. under reduced pressure. This gives 1059 g of the title compound. The product has an optical purity of 99% ee.

### 2. Use Examples

2.1. Protection of Corn Against Infestation with Rhizoctonia solani

An isolate of Rhizoctonia solani originally isolated from maize was grown on potatoe dextrose agar (PDA) at 20° C. in the dark for 14 days. A vermiculite/maize meal/distilled water mixture (2.7:1:1) was autoclaved at 121° C. for 30 minutes in poly-ethylene “autoclave” bags. Once cool, the mixture was inoculated with 40×5 mm² agar disks cut from the Rhizoctonia solani cultures and mixed well. The inoculum bags were sealed and then incubated for 14 days at 22° C. with 16 hours light and 8 hours dark periods. Successful growth was checked by extracting granules of vermiculate and plating on PDA. Infested soil was prepared by mixing peat: sharp washed sand (3:1), removing any large peat clumps, adding maize meal mixture (9:1) and combining the two wells.

Corn seed was either treated with a slurry comprising triticonazole and/or prochloraz in water so that the amounts indicated below were applied per 100 kg of seed, or left untreated (control). Small-parcel fields (1×2 m) were infested with Rhizoctonia solani as described above. After sowing and emergence the number of seedlings surviving (from 50) was determined.

The results are summarized in the following table:

TABLE 1

| | | Percentage |
|---|---|---|
| | | of plants |
| Triticonazole | Prochloraz | surviving |
| [gai/100 kg] | [gai/100 kg] | [%] |
| — | — | 46 |
| 5 | — | 36 |
| 5 | 15 | 62 |

2.2. Protection of Corn Against Infestation with Pythium ultimum

An isolate of Pythium ultimum originally isolated from maize was grown on potatoe dex-trose agar (PDA) at 22° C. in the dark for 14 days. A vermiculate/maize meal/distilled water mixture (2.7:1:1) was autoclaved at 121° C. for 30 minutes in polyethylene “auto-clave” bags. Once cool, the mixture was inoculated with 40×5 mm² agar disks cut from the Pyhtium ultimum cultures and mixed well. The inoculum bags were sealed and then incubated for 14 days at 21° C. for 14 days in the dark. Successful growth was checked by extracting granules of vermiculate and plating on PDA. Infested soil was prepared by mixing peat: sharp washed sand (3:1) removing any large peat clumps, adding maize meal mixture (40:60 v/v) and combining the two well.

Corn seed was either treated with a slurry comprising triticonazole and/or prochloraz in water so that the amounts indicated below were applied per 100 kg of seed, or left untreated (control). Small-parcel fields (1×2 m) were infested with Pythium ultimum as described above. After sowing and emergence the seedlings the disease index (based on a weighted 0-5 infection scale) was determined.

TABLE 2

| Triticonazole | Prochloraz | Disease index |
|---|---|---|
| [gai/100 kg] | [gai/100 kg] | [%] |
| — | — | 70 |
| 5 | — | 71 |
| 5 | 15 | 53 |
| 6 | 18 | 48 |

1. A method for protecting a plant against a phytopathogen selected from the genera Pythium and Rhizoctonia, wherein the seed of the plant is treated with (a) triticonazole or an agriculturally acceptable salt thereof and (b) prochloraz or an agriculturally acceptable salt thereof.

2. The method according to claim 1 wherein the plant is selected from the group consisting of lawn grasses, rice, corn, cotton, oilseed rape, sunflowers, sugarbeet, soybean and vegetables, and the phytopathogen is a Pythium species, or the plant is selected from the group consisting of cotton, rice, potatoes, lawn grasses, corn, oilseed rape, sugarbeet, soybean and vegetables, and the phytopathogen is a Rhizoctonia species.

3. The method according to claim 2 wherein the plant is oilseed rape and the phytopathogen is a Pythium species.

4. The method according to claim 2 wherein the plant is sugarbeet and the phytopathogen is a Pythium species.

5. The method according to claim 2 wherein the plant is oilseed rape and the phytopathogen is a Rhizoctonia species.

6. The method according to claim 2 wherein the plant is sugarbeet and the phytopathogen is a Rhizoctonia species.

7. The method according to claim 1 wherein the Pythium species is Pythium ultimum.

8. The method according to claim 1 wherein the Rhizoctonia species is Rhizoctonia solani.

9. (canceled)

10. An agent for treating seed of a plant for protecting the plant against a phytopathogen selected from the genera Pythium and Rhizoctonia, the agent comprising (a) triticonazole or an agriculturally acceptable salt thereof and (b) prochloraz or an agriculturally acceptable salt thereof.

11. The agent according to claim 10 in the form of a kit comprising a first component comprising (a) triticonazole or an agriculturally acceptable salt thereof and at least one further component comprising (b) prochloraz or an agriculturally acceptable salt thereof.
